(19) United States
(12) Patent Application Publication
(10) Pub. No.: US 2024/0253655 A1
(43) Pub. Date: Aug. 1, 2024

(54) Acoustic Artificial Intelligence Model for Detecting Events Associated with a Vehicle

(71) Applicant: Global Sense Inc., Solana Beach, CA (US)

(72) Inventor: Saeid Safavi, San Diego, CA (US)

(21) Appl. No.: 18/429,330

(22) Filed: Jan. 31, 2024

Related U.S. Application Data
(60) Provisional application No. 63/482,679, filed on Feb. 1, 2023.

(51) Int. Cl. B60W 50/14; G01M 17/013

(52) U.S. Cl. CPC B60W 50/14; G01M 17/013; B60W 2050/143

(57) ABSTRACT

Various embodiments of a method and apparatus for detecting noises associated with a vehicle are disclosed. A custom AI module is provided for detecting issues associated with a vehicle, based on the noises detected. The AI modules are placed in locations that are close to the source of different sounds generated in, and by, the vehicle. Tools are provided for selecting, filtering, and enhancing the datasets. The system matches the dynamic range and parameters of the datasets used for training and testing to data received in the field. In some embodiments, the method includes uploading datasets, data segmentation, filtering the datasets, enhancing the datasets, feature extraction, building a model, testing the model, refining the model, deploying the model as firmware, further testing and refining the model and then building an ASIC (Application Specific, Integrated Circuit).

### CLAIM OF PRIORITY TO PREVIOUSLY FILED PROVISIONAL APPLICATION—INCORPORATION BY REFERENCE

This non-provisional application claims priority to an earlier-filed provisional application No. 63/482,679 filed Feb. 1, 2023, entitled “Acoustic Artificial Intelligence Model for Detecting Events Associates with a Vehicle” (ATTY DOCKET NO. GS-001-PROV), and all its contents, are hereby incorporated by reference herein as if set forth in full.

### BACKGROUND

### (1) Field Technical

The disclosed method and apparatus relate generally to systems for acoustic detection of events associated with a vehicle. In particular, the disclosed method and apparatus relate to use of an artificial intelligence model for detecting acoustic events associated with a vehicle.

### (2) Background

Some vehicles include various sensors for detecting an engine's functioning. Similarly, some vehicles have alarm systems installed to detect vandalism and theft. However, there is a need to improve such systems. Vehicles cannot hear sounds and observe the events associated with the surroundings. Additionally, current alarm systems do not respond promptly to safety and security threats. Also, the sensors in prior art vehicles do not provide information adequate for predicting the need for maintenance, in particular maintenance issues related to vehicle tires.

Accordingly, it would be advantageous to provide a system that can detect sounds associated with vehicles.

### SUMMARY

Various embodiments of a method and apparatus having customizable, smart AI (Artificial Intelligence) modules for sensing the operation and functioning of automotive systems are disclosed. In this specification, AI refers to a system that learns. In some embodiments, the learning is based on input/output data sets. In some embodiments, the input is acoustic data, and the output is a designation of what the input data represents (e.g., a break-in or a faulty transmission). In this specification, the term “module” refers to a hardware or software unit.

An AI platform having AI modules is provided. The AI modules detect events using a combination of acoustic sensors, visual sensors, pressure sensors, temperature sensors and various other sensors to enable real-time automotive security, safety and maintenance services. In some embodiments, a dynamic range of the training and testing data is matched to a dynamic range of sounds received by an audio module in the field. In some embodiments, correlations are computed matching the transfer function for the data for building a model to the transfer function of the recording device, by plotting the amplitude of a given event recorded in the data against a similar event recorded by the system. In some embodiments, the correlation between the transfer functions also takes into account the limits of the recording device of the system.

In some embodiments, the system includes an AI engine (which is a module) having a sound sensor and MCU (Micro Control Unit). The system also includes a separate (or second) module that acts as a front end for the AI engine. In some embodiments, the second module includes a wireless communication module having an IoT modem and position locator. In some embodiments, the module also includes an orientation/accelerator detector and radio communications unit.

In some embodiments, the platform also includes a mobile application module, a cloud analytics module and a cloud storage module to assist the platform in detecting failures, operational issues and maintenance issues related to various parts of the vehicle.

In some embodiments, the process of creating the AI model that has three phases. In the first phase, a customized model is built, which includes AI-driven discovery, loading training data and exporting code that was compiled to a target platform. The AI model is a correlation of characteristics of the data to different events or states associated with the engine or vehicle. In the second phase, field data is collected and further refined. In the third phase, the AI model is deployed, by building an AI model and constructing an ASIC (Application Specific Integrated Circuit) implementing the AI model.

In some embodiments, as part of phases I, II, or III, recorded datasets and public/private datasets are input to a data preparation module. In some embodiments, the recorded data is uploaded, segmented, statistically analyzed and augmented, and an analysis of the coverage of the data is performed. The data preparation module feeds a processed-data module, which performs feature extraction. The processed-data module feeds the model-building module, which performs training and testing. The model-building module feeds a model-deployment module, to create custom firmware, which performs a binary build. The custom firmware then performs on-device testing. Results of the model building, model deployment and on-device testing are fed back to the feature extraction to further refine the model.

In some embodiments, the AI modules are located throughout the vehicle, including difficult-to-reach areas. In some embodiments, at least one audio collection device is placed near each component of interest, which facilitates collecting data locally. In some embodiments, each microphone is located in an AI module at each location. In some embodiments, some AI modules are located on a bell housing of a vehicle engine, firewall and chassis.

In some embodiments, A data augmentation toolset is provided for interacting with third-party tools. In some embodiments, tools are provided including a user interface for uploading data, segmenting and augmenting data. The user interface also provides visual charts of the characteristics of the data and tools for selecting the characteristics of the different classes of data. The user interface includes sliders for setting parameters for enhancing or selecting data. The user interface also includes interfaces for setting a method for enhancing data and choosing the class of data to enhance with that method.

It is cheaper, simpler and quicker to build a model of an environment based on target environments than to run the vehicle in the field and build a dataset based on live-use conditions. Additionally, building the model based on target usages/environments has no performance penalty.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 illustrates a block diagram of some embodiments of a wireless detector system.

FIG. 2 illustrates a block diagram of some embodiments of a network system in which the system of FIG. 1 is deployed.

FIG. 3 illustrates a flowchart of some embodiments of a method of building a model.

FIG. 4 illustrates a flowchart of some embodiments of a method of building a model that is usable with the method of FIG. 3.

FIG. 5 illustrates a chart having two plots of the acoustic signals of similar events recorded by different devices.

FIG. 6 illustrates a chart plotting the ratio of the amplitude of the event's sound signal (in decibels) as recorded by one device to the amplitude of the sound signal (in decibels) of the same event as recorded on the AI engine.

FIGS. 7-11 illustrate other examples of locations where AI modules are placed on a vehicle.

FIGS. 12-15 illustrate screenshots of an embodiment of a user interface associated with tools for building and refining AI modules.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

In various embodiments, an AI platform providing a “Hearing Capability” using a “Local Brain” (Artificial Intelligence (AI)) is introduced, having a custom AI model, which determines the noises of a vehicle on the road, during accidents, in a repair shop or parked and not in use. In some embodiments, the AI model combines acoustic information with other information detected to determine events associated with the functioning of the vehicle and security events (which often occurs while the vehicle is not in use). In some embodiments, acoustic modeling services are included in tracking devices to build/enhance the accuracy of a safety model, which facilitates detecting safety-related events. In some embodiments, the system has a small form factor, a USB (Universal Serial Bus) rechargeable battery, OTA FW (Over-The-Air Firmware), an ultralow power mode, a programmable AI and a new service enabler.

The system collects recorded data and public/private datasets. The data is segmented and augmented, and features are extracted. In some embodiments, some of the augmentations facilitate adjusting the transfer function associated with the data to the transfer function of the AI engine.

In some embodiments, the AI model created is customized to a target environment. In some embodiments, the target environment includes an environment associated with a target geographical location. In some embodiments, the target environment includes an environment associated with a target type of location/environment. In some embodiments, the target environment includes an environment associated with a target usage. In some embodiments, the AI model is customized to the type of engine and type of vehicle.

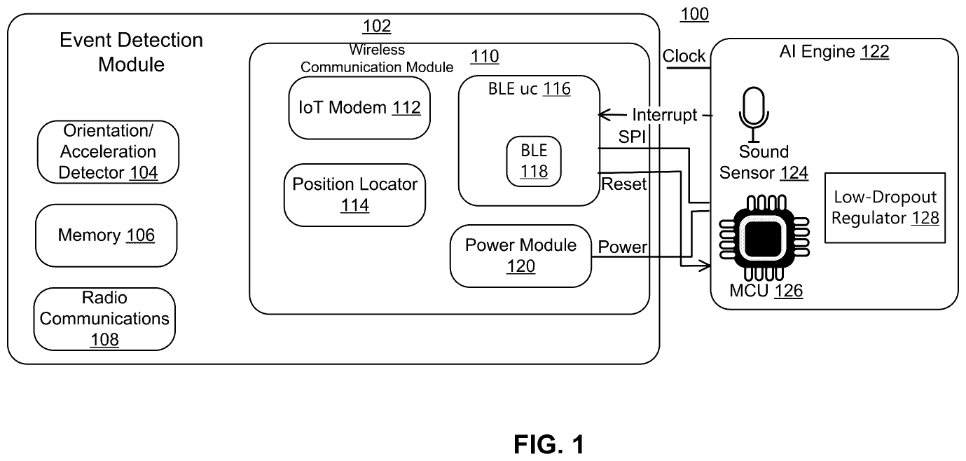

FIG. 1 illustrates a block diagram of some embodiments of a system 100 (which is a wireless detector system). The system 100 includes an event detection module 102 having an orientation/acceleration detector 104, a memory 106, radio communications 108, and a wireless communication module 110. The wireless communication module 110 includes an IoT (Internet of Things) modem 112, a position 114, a BLE pc (Bluetooth Low Energy microcontroller) 116 (which includes a BLE module 118) and a power module 120 (the BLE pc 116/BLE module 118 complies with the BLE or IEEE 802.15.1 standard). The system 100 also includes an AI engine 122, which in turn includes a sound sensor 124, a MCU (Microcontroller Unit) 126 and a low-noise regulator 128.

In some embodiments, the system 100 is an AI system. In some embodiments, the system 100 includes a safety model (for preventing and detecting accidents), a maintenance model and a security model (for detecting break-ins). In some embodiments, the break-in detection includes detecting the breaking of glass, detecting the turning of an ignition and detecting the presence of a person or an intruding object. In some embodiments, the safety model detects crashes/sideswipes, brake noise, tire noise and user-defined events. In some embodiments, the security model includes sideswipe detection and catalytic converter theft detection.

In some embodiments, the security model provide acoustic detection services to existing tracking and detecting devices to detect events, including vehicle break-ins, parked vehicle hits, theft, and other intrusions (the vehicle does not necessarily have any occupants during any of the events detected). The system provides a platform for rapid data collection (e.g., rapid collection of sounds) and labeling of the data (e.g., of the sounds). In some embodiments, the break-ins and other security events are reported immediately to an end user, service provider, authorities (i.e., law enforcement), 911 (with global reach via IoT communications) and enable a deterrent, such as an alarm to stop the intruder and attract attention. Triggering a rapid response can decrease or minimize the damage and increase or maximize the chance of recovering a stolen vehicle, recovering property stolen from the vehicle and catching a vandal.

In some embodiments, the system captures sound outside of the audible range (ultrasound and infrasound signals in combination with vibrations) in addition to other sounds, for fault detection. EVs (Electric Vehicles) emit sounds in the ultrasound and low-frequency ranges, and the usage of ultrasound/infrasound facilitates monitoring EVs, which to the human ear seem relatively quiet. In some embodiments, output from audio sensors is combined with output from temperature sensors, cameras (or other optical sensors), vibration sensors and electrical sensors for sensing the vehicle's functioning and detecting faults.

The system performs predictive maintenance, which includes quick inspection for service centers and smart tracking devices. In some embodiments, a wireless smart microphone connects with a wireless connection, such as Bluetooth, to a smart tracking device. The system 100 performs predictive maintenance and alerts for customers. In some embodiments, analysis of sound-based predictive maintenance, EV (Electrical Vehicle) maintenance information, and sound-based features of vehicles are performed remotely and, in some embodiments, by OEMs. The system 100 can be used for roadside assistance, rental companies and extended warranties. In various embodiments, vehicles in which the system 100 (of the AI platform) is installed in combustion engine systems, electric vehicles, hybrid vehicles, trucks and construction vehicles.

In some embodiments, the event detection module 102 acts as the front end for the AI engine 122. The event detection module 102 is a companion unit for the AI engine 122. Communications between the AI engine 122 and with the Internet and a mobile device occur through the event detection module 102. In some embodiments, the event detection module 102 also includes other sensors, which include the orientation/acceleration detector 104. In some embodiments, the AI engine 102 includes a temperature sensor.

In some embodiments, the orientation/acceleration detector 104 includes an accelerometer system. In some embodiments, the orientation/acceleration detector 104 includes a gyroscope system. In some embodiments, the accelerometer/gyroscope system includes one accelerometer/gyroscope for each of three perpendicular directions (x, y and z), for determining an orientation of the system. In some embodiments, the memory 106 (which in some embodiments is a memory system) includes flash memory. In some embodiments, the memory 106 stores machine instructions, which when implemented by a processor system implements the AI model. In some embodiments, the memory 106 includes at least 4 MB (Mega Bytes) of memory. In some embodiments, the radio communications 108 include Wi-Fi communications (including a wireless network protocol based on the IEEE 802.11 family of standards). In some embodiments, the radio communications 108 are used for communicating with diagnostic equipment and other systems of the vehicle.

In some embodiments, the event detection module 102 is an IoT device including an IoT modem 112, which includes a 4G/5G cellular modem (the 4G/5G standards are wireless cellular standards defined by the International Telecommunication Union (ITU)). In some embodiments, the IoT modem 112 communicates with a network (i.e., the Internet), which facilitates edge computing (at the system 100), allowing for an immediate response to sounds that are sensed by the sound sensor 124, such as a microphone or MEMS microphone. In some embodiments, the edge computing occurs at the vehicle. In some embodiments, the edge computing occurs in a repair shop. The IoT modem 112 is connected, via an LTE NB (Long Term Enhanced Node B), with the Internet. In some embodiments, the event detection module 102 and the AI engine 122 communicate with other devices and sensors, via the IoT modem 112, which are IoT devices.

In some embodiments, the position locator 114 includes a GPS (Global Positioning System) module. In some embodiments, the BLE (Bluetooth Low Energy) pc 116 sends an SPI (Serial Peripheral Interface) communications to the AI engine 122 and can send or resend signals to the AI engine 122.

In some embodiments, the AI engine 122 is an AI module that is included in a disposable coin-battery-operated device that can detect and report faults and detect other issues. In some embodiments, the AI engine 122 includes a neural network. In some embodiments, in which the AI engine 122 includes a neural network, the AI model includes an array of weights assigned to neural connections. In some embodiments, the model includes a specification of which neurons are connected to one another. In some embodiments, the model includes a specification of the number of layers of neurons in the model and the type of connections (i.e., the type of logic circuits or the processing units) connecting neurons of one layer to neurons of another layer.

In some embodiments, the BLE 118 communicates with the AI engine 122. The AI engine 122 also receives a clock signal, which in some embodiments is 32768 Hz. In some embodiments, the sound sensor 124 includes a MEM (Micro-Electro-Mechanical) microphone. In some embodiments, the MCU 126 includes a custom audio MCU. In some embodiments, the MCU 126 may include a memory system that stores machine instructions to collect data and implement the AI model. In some embodiments, the low-noise regulator 128 includes a 0.9V LDO (Low Dropout) regulator. The low-noise regulator 128 keeps the switching noise low, so that the switching noise does not interfere with the noises picked up by the sound sensor 124. In some embodiments, when the sound sensor 124 senses a sound, the sound is analyzed, and if appropriate (i.e., when an immediate response is needed), an interrupt signal is sent to the event detection module 102, which immediately sends alert signals to the cloud and connected applications running on mobile devices.

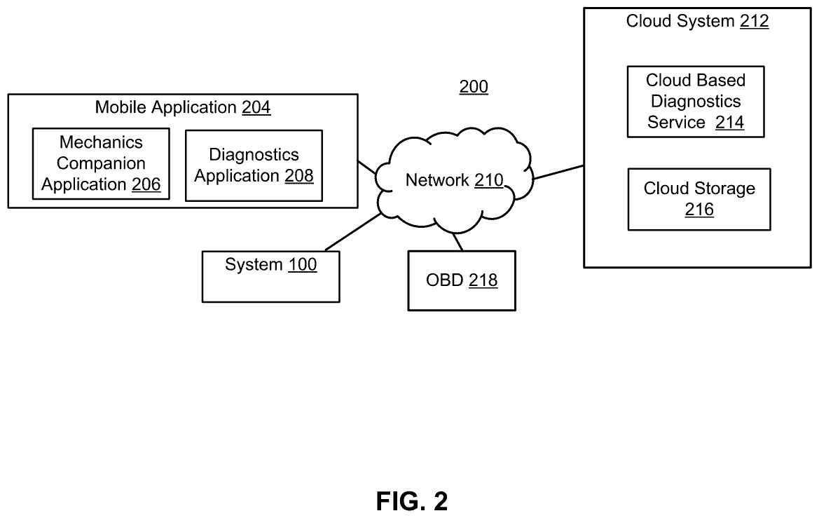

FIG. 2 illustrates a block diagram of some embodiments of a network system 200 in which the system of FIG. 1 is deployed. In addition to the system 100, the network system 200 includes a mobile device 202 having an application 204 having a mechanics companion application 206 and a diagnostics application 208, a network 210, a cloud system 212 having a cloud-based diagnostics system 214 and a cloud storage 216. The network system 200 also includes OBD (On Board Diagnostics) 218.

The application 204 allows the user to interact with the system 100, via the network 210. The mechanic's companion application 206 collects and curates data and uploads the data that was collected to the cloud. In some embodiments, the mobile application 206 can record and play back noises associated with a vehicle. The diagnostics application 208 also records and uploads data (via the IoT modem 112) to the cloud. The diagnostics application 208 also performs diagnostics of the sounds (without necessarily requiring the data to be uploaded to the cloud). Quick fault diagnosis is facilitated via signals from sensors (which are in close proximity to parts of the engine) being sent to a mechanic's (or technician's) terminal (i.e., a mobile device) for analysis, and which in some embodiments, is sent to the OEM (Original Equipment Manufacturer) for analysis to supplement/enhance an analysis of a local AI for quick fault detection. The mechanic's mobile terminal has an AI application, which in some embodiments includes an AI model. The cloud system 212 facilitates immediate responses to break-ins and other security events, such as by placing an emergency call. In some embodiments, the cloud diagnostics 214 interacts with the OBD 218. The cloud diagnostics 214 receives information from the OBD 218. The mobile device 202 has the diagnostics application 208 and the cloud system 212 and includes a processor system and memory storing machine instruction, which when implemented by a processor system, cause the processor system to implement the methods of FIGS. 1-15. In some embodiments, the cloud diagnostics 214 updates or builds anew, the application 204 and the OBD 218 with a new AI model. In some embodiments, the updates to the AI model are sent to multiple OBDs and mobile applications, so that the OBDs and applications are updated on an ongoing basis. In some embodiments, the OBD 218 is located in system 100.

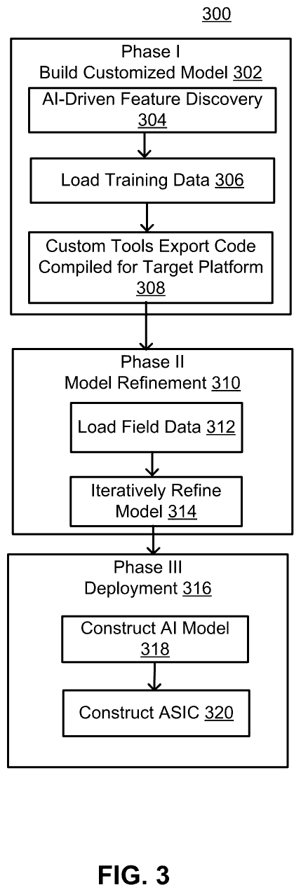

FIG. 3 illustrates a flowchart of some embodiments of a method 300 of building the AI model. The method 300 includes three phases. During a first phase (phase I), during a step 302, a customized model is built. The customized model represents baseline operations, the customized model includes an AI-driven characterization of the functioning of a vehicle and security event based on training data.

The first phase includes a substep 304, during which features are discovered based on an AI analysis of the data. As part of the substep 304, in some embodiments, multiple acoustic spectra and recordings of events are compared to events that occurred while the recording and data for constructing the spectra were collected. In a substep 306, training data is loaded. In a substep 308, code (which in some embodiments includes a neural work) is compiled for a custom platform and exported. By taking multiple recordings and spectra for the same type of event, and using the recordings and spectra as training data, the AI engine 122 is trained to recognize a particular type of event despite differences in the specific patterns received. In some embodiments, substep 302/phase I is performed with the mechanic's companion application 206.

In phase II, during a step 310, the model is further refined. As substeps of the step 310, in a step 312, local field data is loaded into system 200, the local application 204 and cloud system 210. In a substep 314, the model is iteratively refined. In some embodiments, step 310/phase II is performed with the diagnostics application 208. In some embodiments, step 310/phase II is performed with the cloud system 210.

The AI model is deployed in phase III (in a step 316). As part of the step 316, in a substep 318, a software version of the AI model is constructed. In some embodiments, building the AI model and running the AI model in the cloud is performed by the cloud system 212. In some embodiments, the substep 318 includes converting the software version of the AI model into firmware and uploading the firmware to a hardware unit (i.e., the AI engine 122). In some embodiments, the firmware is programmable.

In a substep 320, an ASIC is constructed that implements the AI model. In some cases, the ASIC runs firmware that implements the AI model. In some embodiments, substep 320 is optional and is performed after the AI model has been successfully deployed in the field for a specified period of time (i.e., a year). In some embodiments, the programmable model is hardwired into an ASIC that supports stochastic computing and reduces power consumption by an order of magnitude as compared to had the model not been hardwired into the ASIC. Using stochastic computing for acoustic event detection provides a computational mechanism that can reduce the hardware complexity without a performance penalty.

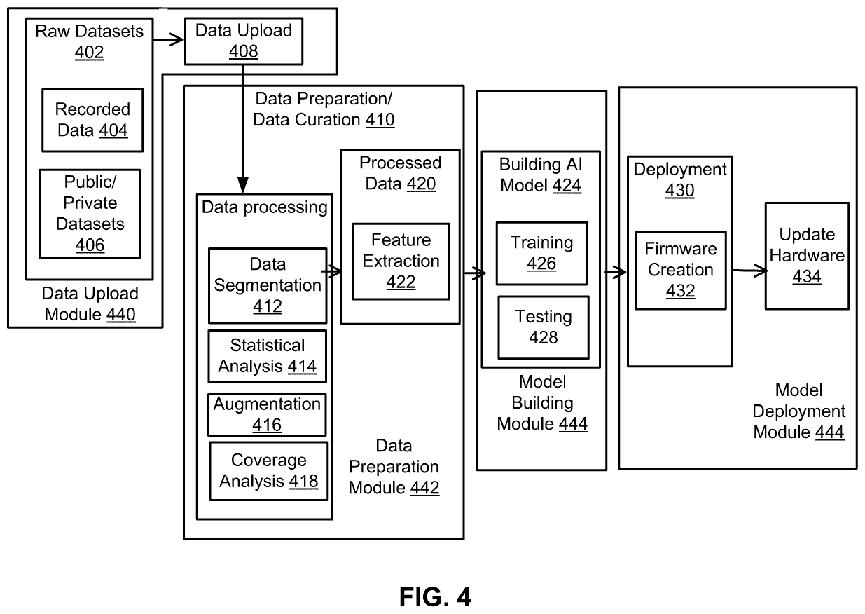

FIG. 4 illustrates a flowchart of some embodiments of another method 400 of building a model. In some embodiments, method 400 is performed during each of phases I and II. In some embodiments, method 400 is also performed during phase III.

In step 402, raw datasets are identified, which include previously recorded data 404 and public/private data 406. In a step 408, the raw datasets of the step 402 are uploaded. In a step 410, data preparation and curation are performed. As part of the step 410, the data is processed in step 412. As part of step 412, in a substep 414, the data is categorized (i.e., segmented). In some embodiments, the substep 414 includes associating patterns of acoustic waves with the events during which the acoustic waves were produced. In some embodiments, the substep 414 includes associating acoustic spectra with the events during which the spectra occurred. In some embodiments, the substep 414 includes separating the data into training and testing data. The training data is different from the testing data, so that after the system 100 is trained, system 100 can be tested using data to which system 100 was not previously exposed, to see how well system 100 has been trained. In some embodiments, a method is used for feature extraction that creates a two dimensional array of values with vertical axis representing frequency bins and horizontal axis representing time interval. This form of feature extraction have different variants like Spectrogram, MFE, MFCC, etc.

In a substep 416, the data is analyzed statistically. The substep 416 includes determining peak values, mean values and standard deviations of parameters/values of interest. In some embodiments, the parameter of interest is the amplitude of the sound signal. In some embodiments, the parameter of interest is the frequency of the sound signal. In some embodiments, the parameter of interest is the time interval of the sound signal. In some embodiments, the substep 416 includes identifying tolerances for the patterns of waves, the frequency, the amplitude and the width of the wave patterns and spectra that characterize particular types of events.

In some embodiments, the substep 416 includes removing background noise from the datasets and removing anomalous datasets (i.e., not consistent with the rest of the data). In some embodiments, the augmentation of the substep 416 includes removing anomalous data from datasets. In some embodiments, the removal of the anomalous data includes removing waveforms and spectral peaks that are outliers.

In some embodiments, in the augmentation of the substep 418, the removal of the anomalous data includes removing recordings of spectra and waveforms that are not sufficiently close to a characteristic spectrum and to a characteristic waveform. In some embodiments, the augmentation of the substep 418 includes superimposing two recordings—one recording being a recording of an event of interest and a second recording including background noise (to ensure that the event is identified by the AI engine 122 despite the presence of the noise). In some embodiments, the augmentation of the substep 418 includes distorting the recording of the event slightly (to ensure that the event is identified despite the distortion). In some embodiments, the distortion of the substep 418 includes shifting a waveform or the spectra of an event of interest. In some embodiments, the distortion of the substep 418 includes broadening the waveform or spectral peaks slightly. In some embodiments, the data augmentation includes deemphasizing (i.e., decreasing the amplitude) the portions of the waveform or spectra that is not unique to an event associated with the waveform or spectra and emphasizing (i.e., increasing the amplitude of) data that is unique to the event. For example, the data augmentation may deemphasize data is not characteristic of the event in question. For example, in some embodiments, sounds that occur both when tire issues arise and when glass shatters are deemphasized compared to features that are unique to glass shattering or tire issues.

In some embodiments, in the substep 418, the data is augmented, which in some embodiments includes adjusting the dynamic range to be that of AI engine 122. In some embodiments, the dynamic range (an indication of a ratio of a maximum and minimum signal value—the ratio of a maximum amplitude to a minimum meaningful amplitude) of the data is adjusted to ensure that the dynamic range of the recording matches the sounds received by the AI engine 122 in the field. In some embodiments, the minimum meaningful amplitude is the amplitude of the background noise. In some embodiments, the dynamic range is computed by the formula, 20 Log₁₀ (Amplitude_{Max}/Amplitude_{Background-Noise}).

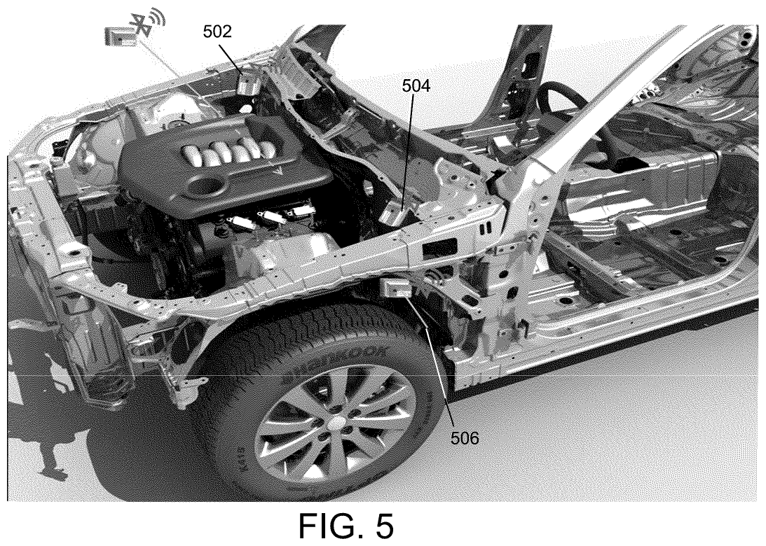

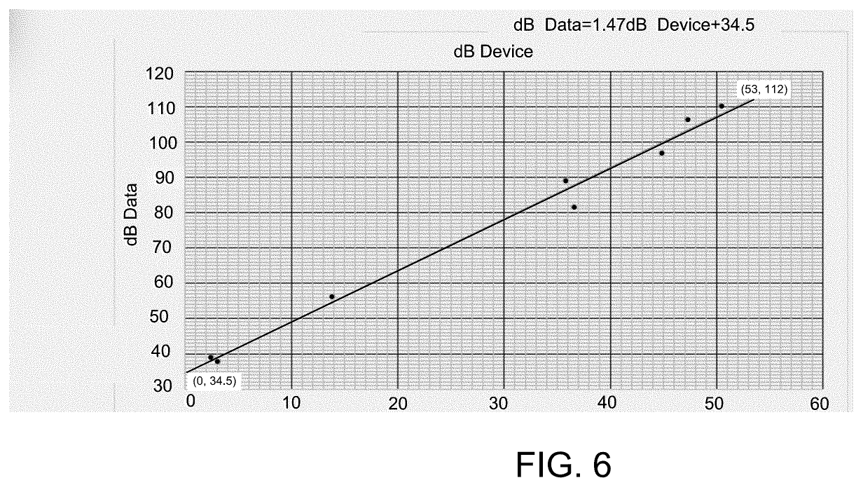

Different recording devices have different transfer functions. Each transfer function emphasizes or deemphasizes different frequencies. The human ear has a transfer function. Some of the data retrieved from public records may be recorded using a transfer function that represents the human ear (dB(A)). As part of substep 418, a function is derived for converting the transfer function of the device recording the data to the microphone of the AI module. An example of a function for converting the transfer function from one device to another device is discussed further in conjunction with FIGS. 5 and 6.

In some embodiments, the training data is also augmented to reflect the system limitations. For example, in some embodiments, the substep 418 includes determining a maximum height and density of spurious signal spikes that will not interfere with identifying an event and that can be tolerated in the received data. Portions of data having a density of spurious signal spikes greater than the maximum density or having signal peaks higher than the maximum may be removed from the training and testing data. For example, the microphone may not pick up certain frequencies or may saturate if the sound is too loud. Similarly, since the AI module only has a fixed number of bits or a fixed amount of memory with which to represent the sound, if the sound is too loud, the signal may appear saturated (even if the microphone is capable of reliably picking up that volume), because there may not be enough bits to represent high amplitudes. By modifying the data to reflect the system limitations, the statistical parameters become more meaningful, because the statistical parameters reflect the statistics of the data that system 100 can discern. An example of how device limitations are taken into account is discussed in conjunction with FIG. 6.

In a substep 420, the event coverage, the range of types of events that can be identified is determined. If the event coverage is insufficient, more data is collected, and the event coverage is increased. For example, suppose the data includes recordings for events associated with crashes occurring in front of vehicles, but the system does not have data for crashes occurring at the rear of the vehicles. In that case, data/recordings for crash events occurring at the rear of the vehicle are added to the data set. Also, in some embodiments, a similar amount of data is stored for each class of data. If a particular type of event has less data than other types of events, more data characterizing that particular type of event is added (or some data may be removed from those classes having more data than others), so that the amount of data of each class is similar. In some embodiments, for diagnosing engine issues and driving events, the classes of data should include a class for the normal functioning of the engine for normal noises made while driving, respectfully. In some embodiments, for diagnosing security issues, the classes should be included for the normal sounds that occur when the vehicle is not being vandalized, broken into or stolen. A class of data is established for each type of event that is desirable to detect. In some embodiments, during step 418 the coverage of the training data and the testing data are checked. In some embodiments, the coverage of the training data and the testing data is the same or within a threshold difference of one another.

In some embodiments, the substep 420 includes identifying the environments in which the specific events can be identified. Additional sets of data associated with environments that are acoustically and significantly different than the environments of interest can make events occurring in the environment of interest unidentifiable by the system 100.

In a step 422, the data that was prepared and curated is processed. As part of step 422, in a substep 424, features are extracted from the data. In some embodiments, the features include metadata and data identifying characteristics of the data. In some embodiments, the substep 424 includes identifying general characteristics associated with a set of data (i.e., determining statistical parameters of a signal and statistical parameters of a set of signals). In some embodiments, the substep 424 includes identifying a type of event associated with a set of data. In some embodiments, different “flavors” of feature extraction are used, such as MFCC, MFE and Sectrogram, etc.

In a step 426, an AI model is built. As part of the step 426, the following substeps are performed. In a substep 428, the AI engine 122 is trained with the data prepared and curated. During the step 426, the sound exposure level or volume of the training data is set to be, or to be within, a threshold difference of, the expected sound exposure of the AI module at the location where the AI module will be located (the sound exposure level is the integral, over time, of the sound pressure squared).

In a substep 430, the AI model is tested against the data for which the AI model was trained. In some embodiments, the test data is collected in the field under the same/similar conditions in which the model will be deployed (in addition to testing the model against data uploaded from other sources). In a step 432, the updated AI model is deployed. The step 432 includes building firmware/updating firmware. In a substep 434, the AI engine is updated with the updated firmware/firmware updates. In the step 436, the hardware is updated with the firmware that was created in the substep 434. In some embodiments, different tools are provided for implementing different steps of the method 400.

In some embodiments, steps 402-408 are performed by a data update module 440, steps 410-424 are performed by the data preparation module 442, steps 426-430 are performed by the model-building module 444, and steps 432-436 are performed by the model deployment module 446.

In some embodiments, data preparation module 442, data upload module 440, model-building module 444 and model deployment module 446 are part of mobile application 204 or installed on another device. In some embodiments, data preparation module 442, data upload module 440, model-building module 444, and model deployment module 446 are implemented by a processor running computer readable instructions that are stored in memory 106 (FIG. 1).

In some embodiments, data preparation module 442, data upload module 440, model-building module 444 and model deployment module 446 are implemented by a processor that runs computer readable instructions that are stored and in the cloud. In some such embodiments, the processor is also implemented within a cloud-based system 212.

FIG. 5 illustrates a graph 500 with two plots of similar events recorded by different devices. A plot 502 represents data recorded on a first device (such as a sound pressure level measurement device, which in some embodiments operates on a dBA scale), and a plot 504 represents data recorded on the AI engine 122. In some embodiments, it may be desirable to use the data recorded in plot 502 for training AI engine 122. However, although the two plots represent the same type of event, the plot 502 has a higher volume and a larger dynamic range than the plot 504 (as a result of the AI engine 122 having a different transfer function than the transfer function of the first device).

FIG. 6 illustrates a chart 600 plotting the ratio of the amplitude of the event's sound signal (e.g., in decibels) as recorded by one device as data and the amplitude of the sound signal (in decibels) to the same event as recorded on the AI engine 122, which corresponds to the signal of FIG. 5. In some embodiments, the signal amplitude is the amplitude of the pressure wave associated with the sound. In some embodiments, the amplitude of the signal is modeled approximately by the voltage produced by a microphone receiving the signal. In the example of FIGS. 5 and 6, the data from FIG. 5 is averaged over fixed time durations to arrive at the data points of the scatter plot of FIG. 6. For example, the data points are binned into one-second-long bins, and the data points within the same bin are averaged. Next, a straight line is fitted to the data points. If more data is present or if the precision of the data is sufficiently high, another curve (i.e., a polynomial or a logarithmic plot is fitted to the data of FIG. 6). Although FIG. 6 illustrates a straight line extending to a point (53 dB, 112 dB), the AI module may saturate at a lower volume/amplitude. At the saturation volume, although the volume of the data can assume higher values, the volume is higher than the value of the AI module can receive. For example, note that the device's 40 dB value corresponds to the 93 dB data value. If the device saturates at 40 dB, then for data values of 93 dB and higher, the value received by the device is still 40 dB.

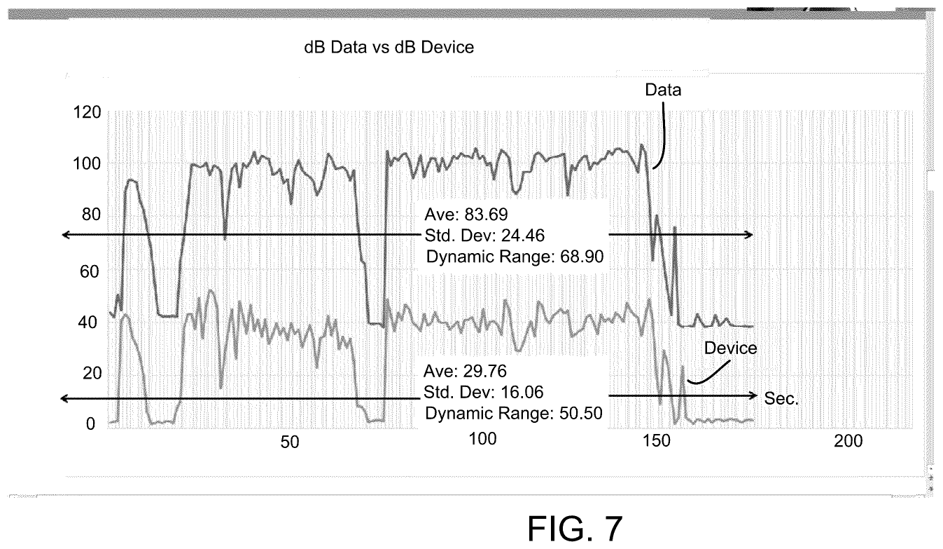

FIGS. 7-11 illustrate examples of locations where the AI modules (systems 100) are placed on the vehicle. Regarding FIG. 7, AI modules 702 and 704 are placed in the two back corners under the hood at the back wall (i.e., near/on the firewall, which separates the engine compartment from the cabin). An AI module 706 is placed on the body above the front wheel within the wheel well—one AI module is placed above each front wheel. In some embodiments, an AI module is placed above each wheel (for detecting issues related to the tires and the causes of abnormal tire and road noise).

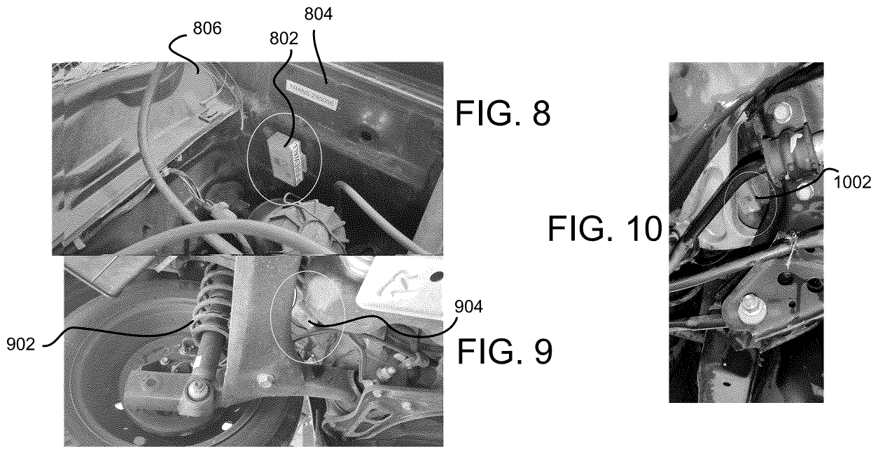

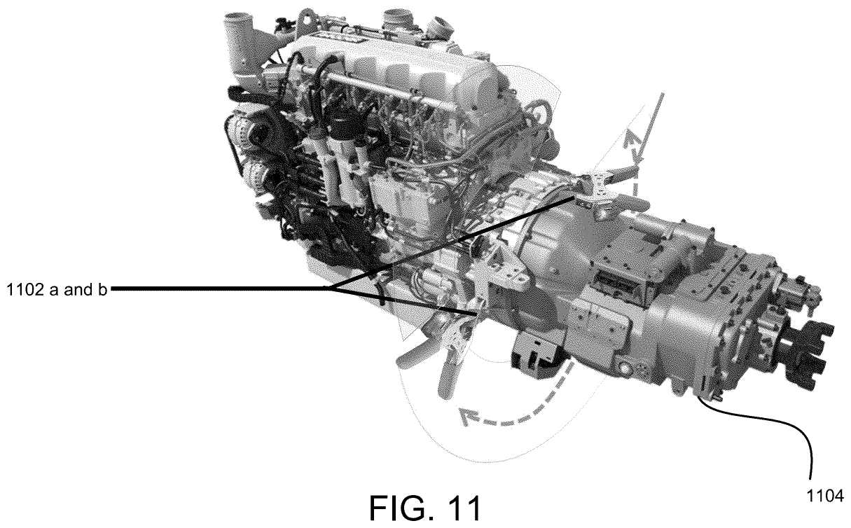

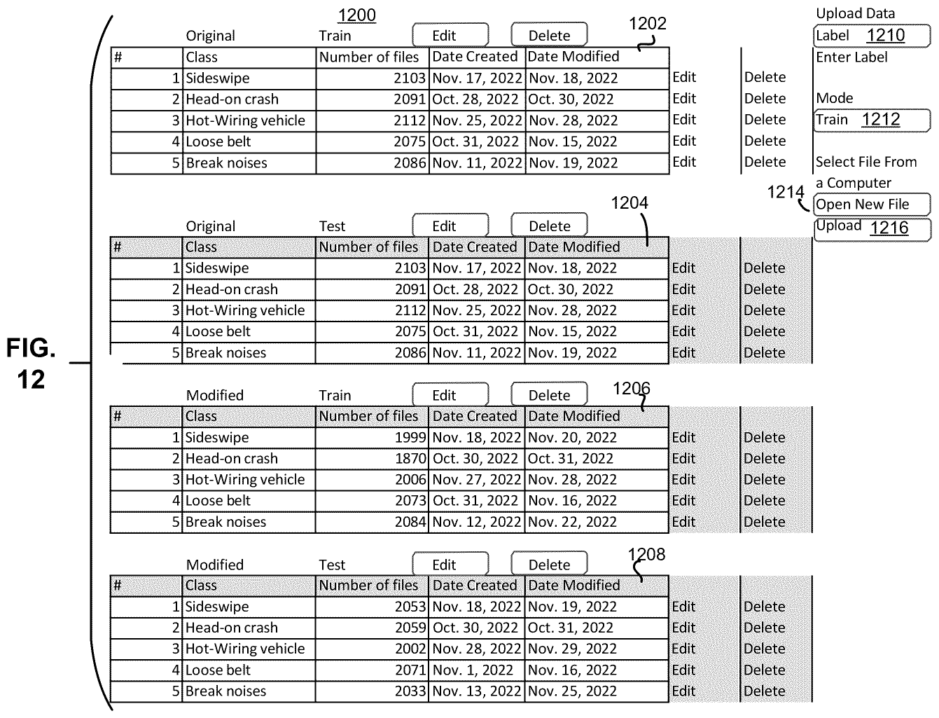

In FIG. 8, an AI module 802 is located on a firewall 804 within a set distance of an engine 806. In FIG. 9, an AI module 902 is located on the underside of the automobile body near a coil spring 904 and within a set distance of a wheel. In FIG. 10, an AI module 1002 is located within a set distance of the sway bar/steering mechanism of the vehicle. In FIG. 11, AI modules 1102 a and b are located on a bell housing 1104 of the vehicle engine. In some embodiments, one or more AI modules are located in the vehicle's cabin. In some embodiments, the system 200 compares stored data to current sounds from the accessory belt, vacuum pump and turbocharger and detects combustion noises, piston noises and transmission rattle (or other noises), and then determines whether an action should be taken (i.e., inform a driver, mechanic or emergency service).

FIGS. 12-15 illustrate screenshots of an embodiment of a user interface associated with tools for building and refining AI modules.

FIG. 12 illustrates an interface 1200 for uploading the data and selecting data for further processing (having data upload tools and data selection tools). The top two panels 1202 and 1204 include original data (i.e., raw data). The top panel 1202 contains data uploaded to train the AI module of system 100 (and build an AI model), and the second panel 1204 contains data uploaded to test the AI model. In some embodiments, the data is stored in a local memory. The data of the bottom two panels 1206 and 1208 are created by selecting files from the top two sets of files. The data in the bottom two panels 1206 and 1208 is modified and is the data that is intended to be used for training and testing the model. In some embodiments, altering data, such as by removing data (i.e., removing a file having data related to an event, a recording of an event or removing an event) from the data of the panel 1202 creates the data of the panel 1206, and altering the data from the panel 1204 creates the data of the panel 1208.

The interface 1200 of FIG. 12 includes a field 1210 for adding a label to the data, a field 1212 for selecting whether the data is to be used for training or testing, a button for opening a new file 1214 and a button for uploading data 1216. Once the data is uploaded, the data is labeled and dated (based in-part on the input to fields 1210 and 1212). In some embodiments, the data includes multiple files. In some embodiments, using the interface 1200 newly uploaded data is labeled and used to create a new class of data. In some embodiments, using the interface 1200, individual files can be uploaded and added to an existing class.

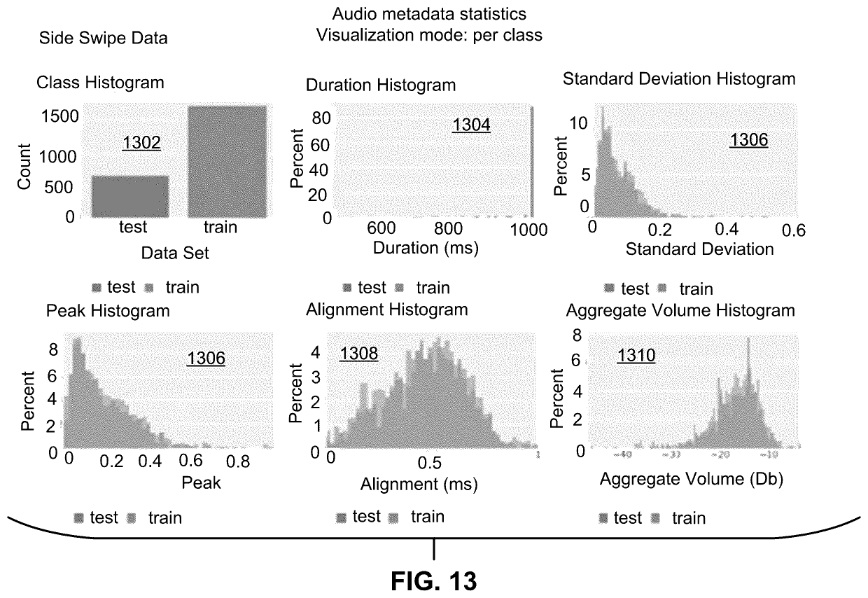

FIG. 13 illustrates an interface 1300 for visualizing data having examples of charts characterizing the data. The example of the interface 1300 includes a chart 1302 indicating how many sets of data are included in a particular class of test data and training data. The example of the interface 1300 includes histograms for a duration 1304, a standard deviation 1306, a peak 1308, an alignment 1310 and an aggregate volume 1312 of a signal. In some embodiments, the duration 1304 is a histogram of the length of the signal characterizing an event. The standard deviation 1306 is a histogram of a standard deviation of an amplitude of a signal generated by an event. The peak 1308 is a histogram of the maximum value of the amplitude of the signal.

The alignment 1310 is a histogram of the duration of time that one signal needs to be shifted to optimize the alignment with another signal. In some embodiments, an average signal is constructed from different recordings of signals representing an event, and a histogram of the durations of times that each signal needs to be shifted to optimize the alignment of the signal with the average signal is represented by the alignment 1310. In some embodiments, the optimum alignment is a duration of a shift required to reach a position that minimizes the sum of the absolute values of the difference of the amplitudes of the signals being compared. In some embodiments, the optimum alignment is a shift required to reach a position that minimizes the root mean square of the differences of amplitudes of the signals being compared.

In some embodiments, the aggregate volume is the aggregate amplitude. In some embodiments, the aggregate volume 1312 of the signal is the integral of the volume over the duration of the signal. In some embodiments, the aggregate volume 1312 of the signal is the sum of the values of the volume across the duration of the signal. The visualization provided by FIG. 13, can be used for visualizing raw data, enhanced data or filtered data. In some embodiments, the visualization is also used for spotting outliers, such as wrong, contaminated, or distorted data.

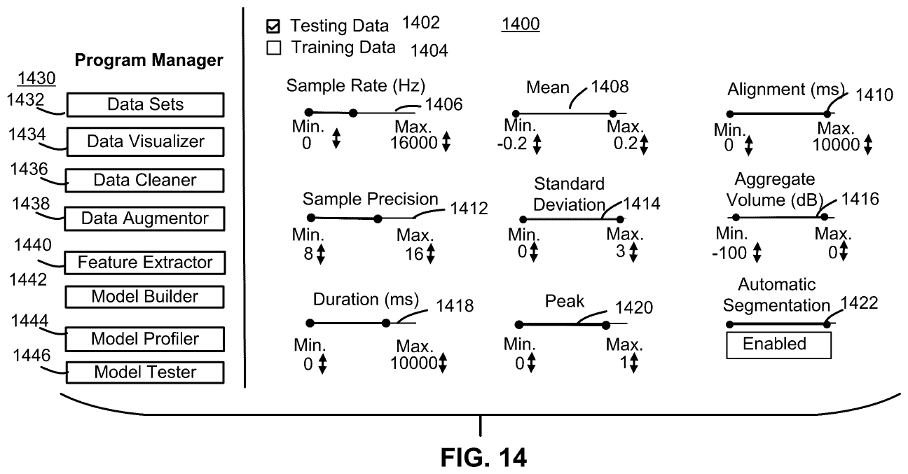

FIG. 14 illustrates an example of an interface 1400 for cleaning data. In some embodiments, the interface 1400 includes a field for indicating whether the data is testing data 1402 and whether the data is training data 1404. The interface 1400 includes tools for adjusting filters or adjusting the manner in which the data is enhanced (depending on user choices, producing filtered data or enhanced data). In some embodiments, the tools are sliders. The tools are capable of filtering the data by removing data for which a particular parameter is not in a particular user-chosen range or enhancing data to have a user-chosen range of values for a parameter. In some embodiments, the interface 1400 also provides tools/filters for selecting or enhancing data based on a sample rate 1406 of the signal (that is how often values of a signal are measured). In some embodiments, the interface 1400 also provides tools/filters for selecting or enhancing data based on a mean value 1408, an alignment 1410, a precision 1412 of the measurement and a standard deviation 1414 (of the mean value) of a parameter of interest (of the signal) and the duration 1418 of the signal. In some embodiments, the tools also filter or enhance the data to satisfy the settings for the aggregate volume 1416 of the signal, the duration 1418 of the signal and the peak value 1420 of the signal. In some embodiments, interface 1400 includes a toggle 1422 for selecting whether to automatically segment (i.e., classify) the data.

The mean value 1408 is a mean value of a parameter of interest. In some embodiments, the alignment 1410, the standard deviation 1414, the aggregate volume 1416, the duration 1418 and the peak value 1420 correspond to and determine the data that create the histograms of the alignment 1310 the standard deviation 1306, the aggregate volume 1312, the duration 1304 and the peak 1308, respectively. In some embodiments, the sample rate 1406, the mean value 1408, the alignment 1410, the precision 1412, the standard deviation 1414, the aggregate volume 416, the duration 1418 and the peak value 1420 relate to the parameter of interest discussed in connection with step 416 and are determined during step 416.

The interface 1400 also includes a navigation panel, which includes a program manager 1430, and which in-turn includes links to interfaces for training and building the AI modules. In some embodiments, the panel having the program manager is provided alongside the other pages of the user interface (including those of FIGS. 12, 13 and 15, for example).

In some embodiments, the program manager 1430 includes a link to interfaces for uploading datasets 1432 and selecting datasets 1434. In some embodiments, the uploading datasets 1432 and the selecting datasets 1434 include a link to the upload module 440 and the interface 1200. In some embodiments, the program manager 1430 includes a data visualizer 1434, a data cleaner 1436, a data augmenter 1438, a feature extractor 1440, a model builder 1442, a model profiler 1444 and a model tester 1446. The data visualizer 1434 provides charts of representatives of the sets of data. In some embodiments, the data visualizer 1434 provides a link to an interface 1300. In some embodiments, the data cleaner 1436 provides a link to interface 1400. In some embodiments, the data augmenter 1438 is a link to interface 1500 (which is discussed below). In some embodiments, the data cleaner 1436 removes anomalous data from a data set or removes data that has parameter values that are outside of user-chosen ranges or outside of automatically determined ranges. In some embodiments, the data cleaner 1436 removes anomalous and irreverent data points from individual recordings of a signal. In some embodiments, the data cleaner 1436 removes recordings of a signal that are anomalous. In some embodiments, data cleaner 1436 provides links to data processing 412. In some embodiments, the data augmenter 1438 provides a link to the augmentation 418. The feature extractor 1440 provides a link to an interface for extracting features from a signal, which in some embodiments is a link to the feature extraction 424.

The model builder 1442 includes a link to an interface for building a model, which in some embodiments is a link to the model building module 444. In some embodiments, the model profiler 1444 provides links to the data segmentation 414, the statistical analysis 416 and the feature extraction 424. In some embodiments, the model tester 1446 provides a link to the testing 430.

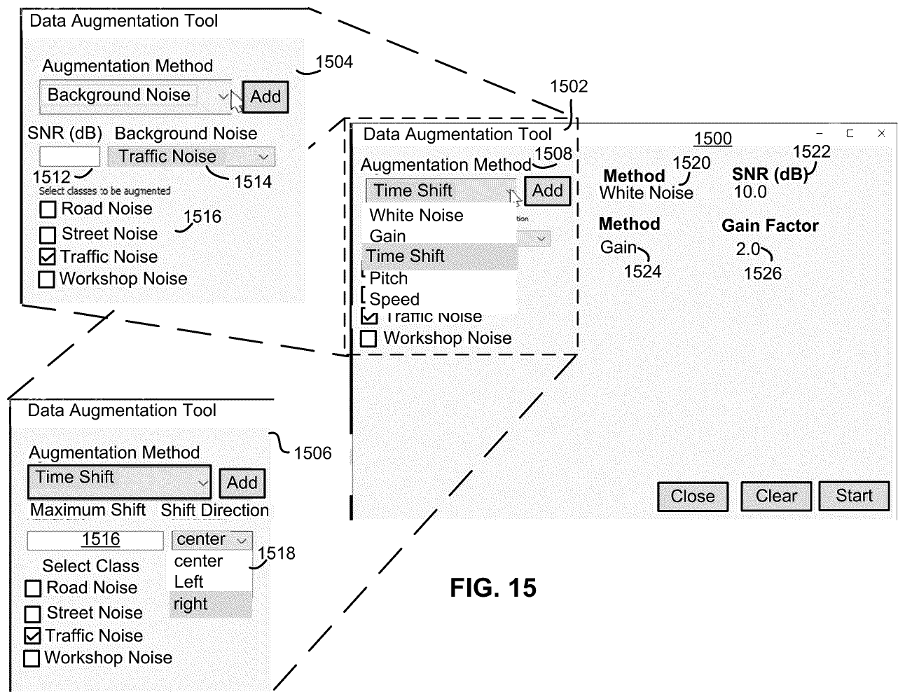

FIG. 15 illustrates some embodiments of an interface 1500 for augmenting data. Details 1504 and 1506 are different states of a detail 1502. The detail 1502 includes a field 1508 for selecting a method/manner in which to augment the data (i.e., whether to adjust the gain, adjust the SNR (Signal to Noise Ratio), add white noise, adjust the pitch or adjust the speed of play of the enhancement data). In some embodiments, the pitch is a function of frequency that orders the frequencies sequentially, but with a different spacing between different frequencies than were the frequencies spaced apart according to the value of the frequency. In some embodiments, the gain is a measure of the ratio of the output amplitude of a signal to the input amplitude of the signal. In some embodiments, the gain is a measure of the ratio of the output power to the input power. In some embodiments, sound pressure is the signal used for computing the gain. In some embodiments, the signal used for computing the gain is the electrical current/voltage representing the sound.

The user can use the detail 1504 to select a class of enhancement data (e.g., street noise, road noise, traffic noise or workshop noise) and SNR for enhancing the data. In some embodiments, the names of the classes and the number of classes of enhancement data are user-chosen.

The user can also use the detail 1506 to select a time shift to apply to a selected class of data, the direction of the shift and the maximum time shift for any given wave pattern.

In the detail 1504, an augmentation method 1508 specifies a manner in which to augment the data. A parameter value field 1512 is a field for entering a value that determines how the augmentation occurs, and a selection field 1514 is used for selecting a further refinement of the method. In the example of the detail 1504, the selection field 1514 is set to SNR, and the value to which the selection field 1514 is set determines the SNR to which to enhance the data. In some embodiments, the amplitude of the background noise of the data is increased or decreased to decrease or increase, respectively, the SNR to the setting of the selection field 1514. In the detail 1506, the method of augmentation is a time shift of the data. In the detail 1506, the parameter value field 1512 determines the maximum desired time shift with which to augment the data, and the selection field 1514 is set to the direction in which to shift the signal. In some embodiments, multiple methods are selectable for augmenting the data, using an add button. A field 1516 determines the set of data or the class of sets of data that is selected for augmentation.

In the example of FIG. 15, the interface 1500 also indicates the SNR 1522 for the white noise 1520 and the gain factor 1526 for the gain 1524. In the example of FIG. 15, two methods for enhancing the data were chosen, as indicated by fields 1520-1526. If more methods are chosen, those methods are also indicated on the interface 1500, in additional fields similar to fields 1520-1526. If different methods are chosen, those methods are indicated on interface 1500 instead of fields 1520-1526. By adjusting the gain factor 1526, the SNR 1522, the peak or other parameters, the user can determine how the datasets are enhanced. By using the interface of FIGS. 12, 14 and 15, the user can shape the data to match the field data by removing or altering parts of the data (by altering sets of data, new data sets can be created for training or testing).

The augmentation methods are typically not combined. For example, gain and SNR are interrelated. Therefore, in some embodiments, it is better to do noise augmentation with specific SNR separate from gain augmentation, since both parameters are inter-related.

Although the interface of FIGS. 12-15 allows the user to filter the data manually (via filtering tools), the filtering and the parameters set by the interface of FIGS. 12-15 can be adjusted automatically without user intervention. In some embodiments, the filtering, the augmentations and the adjustments (to the alignment, the SNR and the gain) are initially applied automatically. Then the user can further tweak the filtering, the augmentation and the adjustments if needed.

In various embodiments, the vehicles include airborne vehicles and vehicles that travel in the water.

Although the disclosed method and apparatus are described above in terms of various examples of embodiments and implementations, it should be understood that the particular features, aspects and functionality described in one or more of the individual embodiments are not limited in their applicability to the particular embodiment with which they are described.

Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/of” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system comprising:
a) a processor system;
b) a memory system, the memory system storing machine instructions, which, when implemented, cause the processor system to generate tools for building an Artificial Intelligence (AI) model that identifies events associated with a vehicle; the tools including
i) a tool for selecting datasets, characterizing a type of event, for training the AI module;
ii) a tool for enhancing the datasets, the tool for enhancing the datasets being configured to alter the datasets to match parameters of the datasets to sounds, as received at the AI module while operating in a field of operation; and
iii) a tool for building the AI model based on the datasets that were enhanced.

2. The system of claim 1, the tool for enhancing the datasets including a tool for adding sounds to the datasets, the sounds characterizing a background noise,

3. The system of claim 2, the tool for adding the sounds including a selection for setting a signal-to-noise ratio.

4. The system of claim 2, the tool for adding the sounds including a selection for setting a gain that determines the amplitude of the background noise.

5. The system of claim 1, further comprising a tool for filtering the datasets the tool for the filtering including a tool for selecting a range of mean values of a parameter characterizing an event to accept in a set of filtered data.

6. The system of claim 5, the tool for the filtering including a tool for selecting a range of sample rates to accept in a set of data.

7. The system of claim 5, the tool for the filtering including a tool for selecting a range of precisions of data to accept in a set of the data.

8. The system of claim 5, the tool for the filtering including a tool for selecting a range of alignments accepted a set of data.

9. The system of claim 1, further including AI modules located in the vehicle.

10. The system of claim 9, one of the AI modules being placed on a bell housing of an engine of the vehicle.

11. The system of claim 9, one of the AI modules being placed in a wheel well of the vehicle.

12. The system of claim 1, the machine instructions include instructions, which, when implemented by the processor system, cause the system to determine a range of the events that are detectable by the datasets.

13. The system of claim 1, further comprising an interrupt that communicates with the AI module, which is configured to send an alert to another device, when a specified event is detected.

14. The system of claim 13, the interrupt comprising:
a) an Internet of Things (IoT) modem; and
b) a position locator.

15. The system of claim 1 further comprising:
a) the AI model being stored in the AT module;
b) the AT model also being stored in a memory unit on a device deployed remotely from the AT module in a network; and
c) an application stored on a mobile device for communicating with the AT module and the AT module being deployed remotely from the mobile device.

16. The system of claim 1 further including an optical sensor, and the datasets include a combination of optical data and acoustic data.

17. The system of claim 1 further including a temperature sensor, and the datasets include a combination of temperature data and acoustic data.

18. A method comprising:
a) building, by a machine, an Artificial Intelligence (AI) module, the machine including a processor system and a memory system, the memory system storing machine instructions, which, when implemented by the processor system, causes the machine to implement the method, the building of the AI module including
b) selecting datasets, by a data selection tool, the datasets characterizing a type of event, for training the AI module; and
d) enhancing the datasets by a toolset for enhancing data, the enhancing including altering the data to match parameters of the datasets to sounds received at the AI module during a field operation; and
the building of an AI model, the AI model being based on the datasets that were enhanced.

19. The method of claim 18, the building of the AI module further including extracting features from the datasets.

20. The method of claim 18, the datasets including prior recorded data and publicly available data.
